(19) United States
(12) Patent Application Publication
(10) Pub. No.: US 2003/0066084 A1
(43) Pub. Date: Apr. 3, 2003

(54) Apparatus and method for transcoding data received by a recording device

(75) Inventor: Peter B. Kaars, Cupertino, CA (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N. V.

(21) Appl. No.: 09/967,756

(22) Filed: Sep. 28, 2001

(51) Int. Cl. H04N 7/173; H04N 7/16

(52) U.S. Cl. 725/89; 725/90; 725/134; 725/142

(57) ABSTRACT

There is provided a system, method and software application that receives a data stream via a data network such as the Internet. The received data is recorded in a data storage device. The system stores various transcoding algorithms for a variety of playback devices and transfer networks. The recorded data is then transcoded into a format compatible with other devices or data transfer constraints. A user can interface with the system to input information particular to the other devices and transfers. This information is stored by the system and used to determine the transcoding algorithm best suited to the needs of the user based on the user input.

### BACKGROUND OF THE INVENTION

1. Field of the Invention

The present invention relates generally to a system and method for transcoding data, and in particular to an apparatus and method for transcoding data received by a recording device.

2. Description of the Related Art

In today's consumer electronics (CE) market companies are introducing a wide variety of electronic devices that are capable of playing audio and/or displaying video. The television and the personal computer (PC) are two common examples of these devices, but several playback devices are available, which include a Wireless Internet Appliance (WIA), a personal digital assistant (PDA), or even a cellular telephone. Quite common in the CE market is the VCR, the use and operation of which is well known. By enabling the user to record a program and play it back at a more convenient time, the VCR has freed the user from the programming timetables of the program providers.

A new device that is emerging on the market is the digital video recorder (DVR), also known as a Personal Video Recorder (PVR). The PVR contains a digital storage device such as a hard disk drive similar to that found in a personal computer for storing digital data. The PVR receives an analog or digital signal. In the former situation the PVR can digitize, compress and store the resulting signal. In the latter situation the PVR can store the digital signal as received. At playback the PVR retrieves and outputs the signal to the output device that is connected to it. The PVR also allows the user to pause, stop, fast-forward and rewind the signal, quite similar to the standard VCR.

Problems may arise in a variety of ways. One example is when the format that is required by the desired output device is not compatible with the input signal format as stored by the PVR. Another example is when the stored data is in a format that cannot be transferred across a network, e.g., the home network, due to format incompatibility, e.g., due to bandwidth constraints. In yet another example, when transcoding is applied on, e.g., a video signal with image enhancing and interpolation algorithms a higher picture quality can be achieved. A generic example of transcoding is, e.g., where certain content that has been previously encoded in a certain format is reencoded to another format. The format in which the signal is received may not be optimally formatted, e.g., in case of a less than optimal compression ratio, for handling it in the PVR, e.g., due to storage capacity constraints.

Therefore, a need exists for a recording device that transcodes data into a format compatible with a playback device, or for a more optimal format for storage, transfer or playback.

There is also a need to accommodate the typically extensive CPU processing required in such transcoding, which may compete with CPU requirements for other processes like reception, storing, decoding and play out of the concerning or other content information.

Finally another problem arises when the PVR cannot perform an optimal compression and storage of the data at the moment of reception.

### SUMMARY

An aspect of the present invention relates to an apparatus for receiving and storing content information in a first data format, and transcoding from the first data format into a second data format, and storing the content information in the second data format.

Another aspect of the present invention relates to an apparatus for transcoding content information from a first data format into a second data format, while accommodating said CPU requirements, independent of the time of reception and independent of the time of play out.

An aspect of the present invention relates to an apparatus for transcoding content information from a first data format into a second data format at a selected rate. The rate is either slower or faster than the real-time play out data rate, and depends on the available resources, especially the processor, of the apparatus. The apparatus is implemented to have more resources available for transcoding processes that are, for instance, less urgent or less time critical. For instance more resources tend to be available for such processes when urgent or time critical processes (like reception, storing, decoding and playout) are not predominantly taking place and, thus, are not in need of such resources. These resources are available in an off-line mode. Here typically, but not exclusively, a mode wherein the apparatus has resources available for less urgent processes, e.g., those that do not necessarily need to be performed in real-time. In a multitask management system (e.g., comprising a task-manager that manages processes and a system that carries out tasks in the apparatus) the order in which tasks are carried out and resources are allocated for such tasks is, e.g., based on a certain priorities and scheduling deadlines. For such a system, the apparatus’ transcoding approach enables certain tasks to be carried out off-line instead of real-time. For example, an MPEG2 encoding can be done achieving a higher compression ratio, whilst not compromising quality, by performing a multi-pass encoding algorithm (or transcoding in case the data is already encoded), a technique known from, e.g., the DVD-Video authoring business.

Yet another aspect of the present invention relates to a method for enabling a user to transcode data received by a recording device.

A further aspect of the present invention relates to a software application for controlling the transcoding of data received by a recording device.

The invention provides a system, method and software application that relate to receiving a data stream via a data network such as a television broadcast or the Internet. The received data is recorded in a data storage device. The system is equipped with one or more transcoding algorithms for one or more playback devices and/or transfer networks. The recorded data is then transcoded into a format compatible with that of other devices or data transfer and/or storage constraints. In one embodiment of the present invention a user can enter into the system information particular to the other devices and transfers. This information is stored by the system and used to determine the transcoding algorithm. The system, upon the command of the user, either plays back the transcoded data on a connected output device, transfers the transcoded data across a connected data network, or uploads the transcoded data into a playback device. In the invention a transfer of data comprises at least one of a reception of the data by an apparatus and a transmission of the data by the apparatus. Examples of the data are an unprocessed data stream, a software module, a transcoded data stream and content information.

### BRIEF DESCRIPTION OF THE DRAWINGS

The present invention will become more apparent from the following detailed description, given by way of example, when taken in conjunction with the accompanying drawings in which:

FIG. 1 is a block diagram of the off-line transcoding system according to an embodiment of the present invention; and

FIGS. 2A and 2B illustrate a flow chart of the process of off-line transcoding according to an embodiment of the present invention.

### DETAILED DESCRIPTION

Embodiments of the present invention will be described herein below with reference to the accompanying drawings. In the following description, well-known functions or constructions are not described in detail since they would obscure the invention in unnecessary detail.

With the onset of the consumer electronics (CE) explosion, comes the problems of compatibility. No manufacturer or retailer desires to place a product on the market just to find that the data format it was designed for is not compatible with the current technology, or to find that it cannot interact with other devices and systems on the market. For example, a device as the Wireless Internet Appliance (WIA, e.g., a WebPad) may support a MPEG4 data format but not MPEG2. “MPEG4” and “MPEG2” refer to two widely used data formats that are well known in the art. Note that within a data format such as based on MPEG2 many data formats exist depending on, e.g., different resolutions and compression ratios etc. As another example, a personal digital assistant (PDA) may only support a transfer and playback bitrate much smaller than that of the received data. If the data is not transcoded, it cannot be stored in and played-back from the PDA. Even current cellular telephone technology is incorporating various data playback features into the mobile telephone. But, since the bitrate of data reception of the cellular telephone is limited, it may be necessary that the data must first be transcoded (transcoding typically, but not exclusively, comprises the steps of: a possible partial or complete decoding of an encoded content followed by a re-encoding) into a compatible format for proper transmission to the mobile phone.

The present invention solves this compatibility problem in a two-step process. First, a storage device receives data in a first format. Second, in an off-line mode, the stored data is transcoded into a desired format. As an example the transcoding can be to a format compatible with the next use of the consumer, whereby the transcoded data is stored in the storage device. Transcoding can be used to take the data from a higher to a lower resolution or with a higher compression ratio (with typically some quality loss). The compatibility transcoding can, e.g., also include a transcoding that includes an image enhancement in order to better match a higher display quality (this may also apply to a sound enhancement in order to better match a higher speaker quality etc.). The consumer may have the ability of interfacing with the system to input information about the output device or network that requires compatibility transcoding. By handling the transcoding in an off-line mode, the system can devote as many resources to the transcoding process as are available, independent of the duration of the signal in real-time. Hence the production of more affordable and interchangeable devices is enabled.

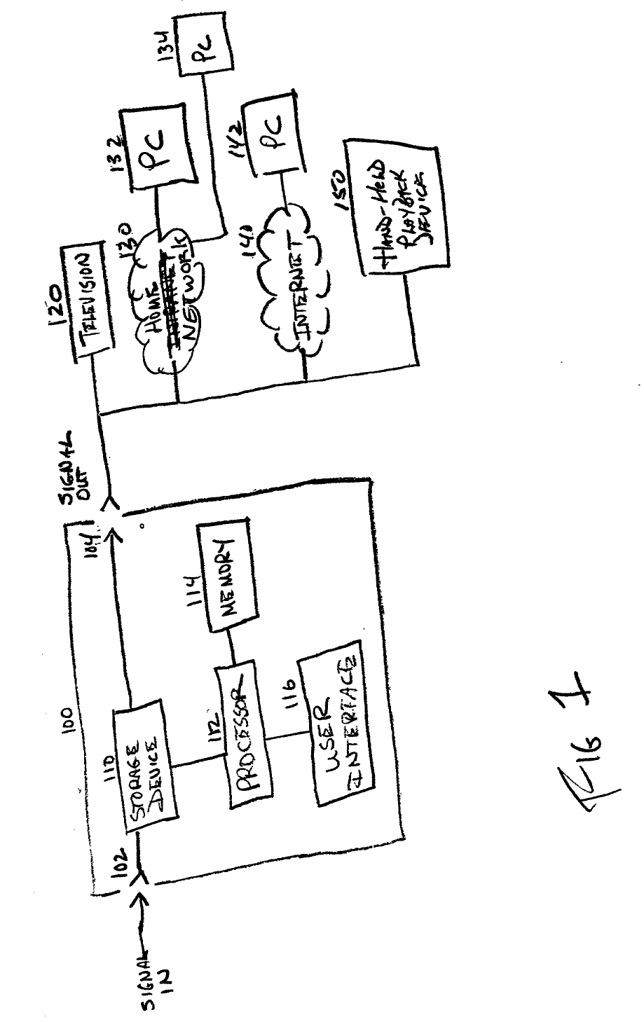

FIG. 1 is a block diagram of an example of an off-line transcoding system. Shown in FIG. 1 is data transcoding device 100 having an input data port 102 and an output data port 104. The data transcoding device 100 contains a storage device 110, a processor 112, a memory 114, and a user interface 116. Storage device 110 is, e.g., a hard disk drive. Although the hard disk drive is here described, solid state memory (e.g., flash memory) or any other technology capable of such a storage function can be used. The processor 112 is a standard control unit for the system. It controls the read/write functions of the storage device 110, loads to and from memory 114 the software programs contained therein, and interacts with the user interface 116. The user interface 116 is, e.g., a simple keypad that accepts codes for different output devices whose data format is stored in the memory 114, which tells the processor which transcoding program to use. It is contemplated that the user interface 116 is also a wireless interface, such as an interactive display on a television, for example a wireless cursor system with various menu levels to enhance user interfacing. Whatever form the user interface takes; the function of the user interface 116 is to enable the user to provide information based upon which the processor transcodes the data.

An alternative may be that the format of data received is determined by the receiving device (e.g., from the file extension or a header) and that the proper transcoding software is, e.g., invoked automatically later on or during the download of the data when convenient. Convenient with respect to the data processing resources available, e.g., free CPU cycles, to the receiving device.

In addition, although not shown in FIG. 1, an A/D converter may be interposed to receive the signal input and convert it from an analog signal to a digital signal before it is stored in storage device 110.

Also shown in FIG. 1 are several output devices connected to the data output port 104. The devices shown are not meant to be inclusive of all actual devices connectable with the 20 system, nor are they system constraints. Shown connected are a television 120, a home network 130 connected to a personal computer (PC) 132 and PC 134, the Internet 140 also connected to a personal computer 142, and a generic hand-held playback device 150. It is well known to those skilled in the art that the input signal for a television differs greatly from an input signal of a personal computer, each requiring different signal processing and format for output. Another constraint of these output devices is their differing storage capacities. For example, a television generally has no storage capacity so the signal it receives is instantly played back. A PC might have the capacity to store several blocks of data representing several digital movies. And a hand-held playback device (which may require yet another signal format) might have storage capabilities for only one content information. In addition to compatibility constraints of the actual playback devices, a home network and the Internet also have inherent constraints such as bandwidth and capacity. For proper playback, the data must be in a format compatible with the particular playback device. Therefore, with the present invention, the user may utilize any of a number of these devices to render (typically, but not exclusively, audio and/or video content information) the same information.

Transcoding of data formats is a CPU-intensive process that typically consumes substantial amounts of random access memory (RAM). Generally, a transcoding process is timeconsuming.

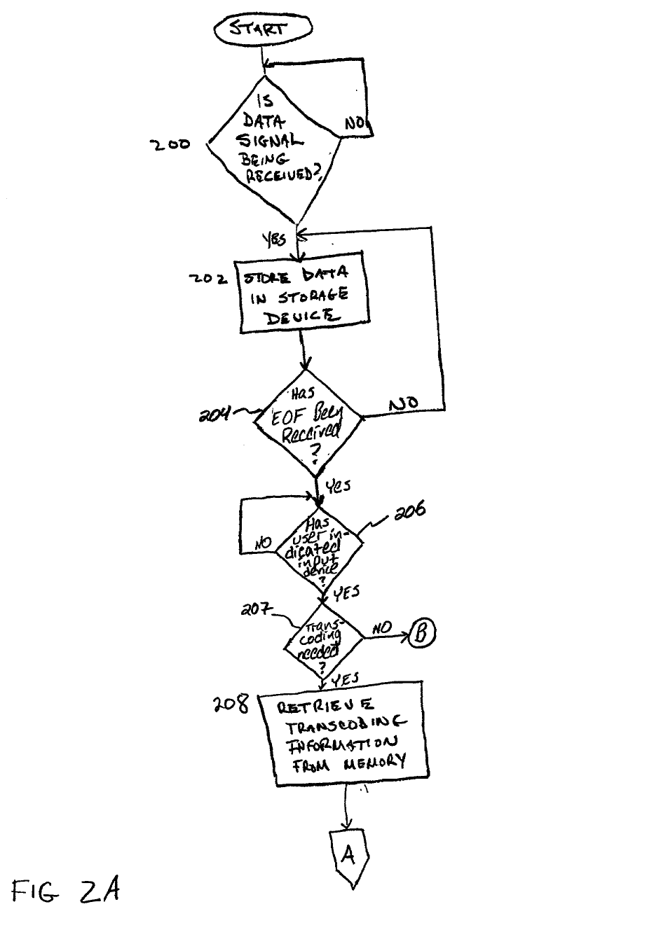

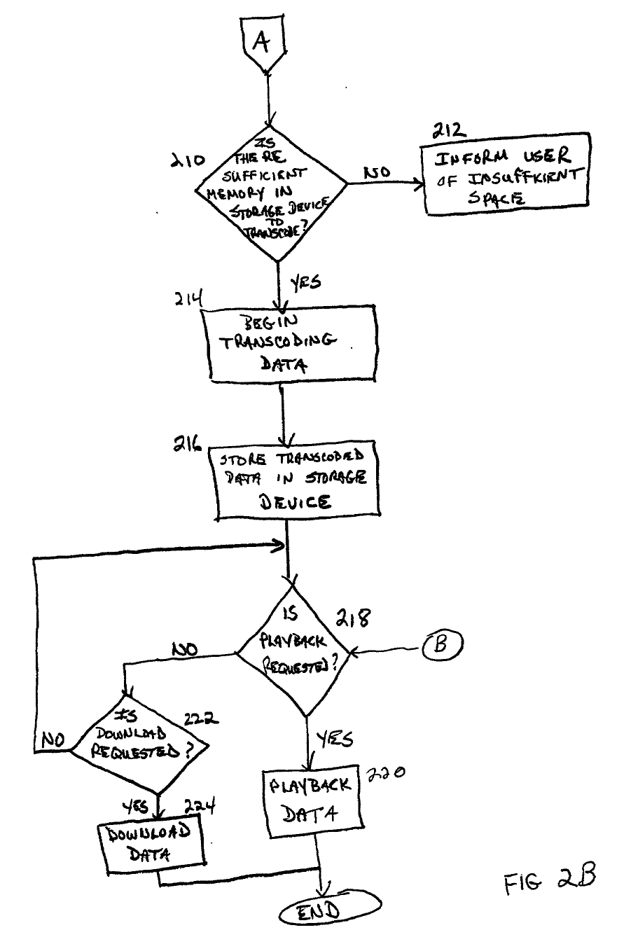

Transcoding is described with reference to FIG. 1 and FIG. 2. FIG. 2 is a flow chart of off-line transcoding process according to one embodiment of the present invention. In step 200 of FIG. 2A, the system awaits an input signal. If a signal is being received the system stores the data in the storage device 110 in step 202. If apparatus resources are available, it is possible for transcoding to begin immediately. In such a case the system will receive data and begin transcoding as the data is being received.

Next, in step 206, the system checks if the user has input, through user interface 116, an indication of a particular playback device. This can be done in the form of a numeric code. If the user has not, the system repeats step 206 until there is an input of the indication of a playback device. If the user has entered a playback device code, the process continues to step 207, where the input signal is analyzed in view of the input device to determine if the formats are compatible and thus whether transcoding is needed. If not, the processing continues at step 218 shown in FIG. 2B and described below. If transcoding is required, the process continues to step 208 wherein the processor 112 retrieves the transcoding information from memory 114. The transcoding information of various output devices is stored in memory 114. In the event a new output device is introduced into the market, the system can download via a data network, for example the Internet, new transcoding algorithms and format information.

Next, in step 210 of FIG. 2B, the processor 112 determines if there is sufficient space on the storage device 110 to store the entire transcoded file. If not, the system in step 212 informs the user of the insufficient space problem. At this point the system may request the user to delete one or more previously stored files to free up space on the storage device 110. The system can also allow the user to compress the existing data to free up needed space. If it is determined in step 210 that there is sufficient space available on the storage device 110, the system continues to step 214 to begin the transcoding process according to the previously entered user input/output device information. As the data is transcoded it is stored in the storage device 110 in step 216.

In step 218 the system determines if a playback request is received from the user. If the playback request is received, the system in step 220 plays back the transcoded data in the format compatible with the playback device. If playback is not requested, the process continues to step 222 to determine if a download is requested. If no download is requested, the process returns to step 218. If a download is requested, the system downloads the data in step 224. The download may be into a hand-held playback device or onto a data network, such as the home network 130 or Internet 140, for storage in one of the attached PCs.

Whatever the particular playback device, the present invention transcodes data stored in a first format into a second format compatible with the playback device or data network of the user.

In this example of the present invention, a software application controls the playback of content information received via a data network. Again the data network may include, for example, the Internet or a home network. A storage algorithm is stored in the memory 114 to enable storing the content information in the storage device 110. At least one transcoding algorithm for transcoding the content information is also stored in the memory 1 14. Different transcoding algorithms can be stored and utilized depending on the particular needs of the user. Finally, a second storage algorithm for storing the transcoded content information in the storage device is included in the memory 1 14. The software also includes user interface algorithms to enable the user to interact with the system as described above. Thus, the software applications will enable the digital recording device to receive, transcode and/or store data according to the needs of the user.

It is also included within the scope of the invention that the software applications enable the system to interact with various playback devices and data networks, thus further enhancing the overall system.

Although an apparatus with transcoding capabilities has been described, similar functionality can also be implemented in a distributed system such as, e.g., can be found in a home network. For example a master in the network manages tasks to be carried out by network subsystems as an input- and output-device, a storage device, a processing and communication device. Therefore a distributed system to achieve the off-line transcoding is also included within the scope of the present invention.

Also included within the scope of the present invention is the ability to download from a network new or updated transcoding algorithms to enable the system to expand as the technology changes. It is also within the scope of the present invention that the apparatus itself or the user may request the proper transcoding software from a service on a network, e.g., the Internet, or the transcoding software gets downloaded from a server, together with the content information according to the specifics uploaded by the user. The server is kept up to date with regard to the equipment residing on the user's home network. For example, if the user receives content information for playback via a new piece of equipment connected to the present invention, but does not have the proper transcoding software, the software may be identified via the user having registered the new piece of equipment with the service. Various types of services are described in the following patent applications, each of which is incorporated herein by reference: “Customized Upgrading of Internet-Enabled Devices Based on User-Profile” assigned U.S. application Ser. No. 09/160,490 (attorney docket PHA 23,500) and filed on Sep. 25, 1998 for Adrian Turner et al. (“Turner et al.”); “Upgrading Of Synergetic Aspects of Home Networks” assigned U.S. application Ser. No. 09/189,535 (attorney docket PHA 23,527) and filed on Nov. 10, 1998 for Shteyn (“Shteyn”); and, “Personalizing CE Equipment Configuration at Server Via Web-Enabled Device” assigned U.S. application Ser. No. 09/519,546 (attorney docket 000014) and filed Mar. 6, 2000 for Ekkel et al. (“Ekkel et al.”).

Another existing apparatus of potential adaptability for identifying and/or acquiring transcoding software for a particular device over a network or the Internet is disclosed in U.S. Pat. No. 6,076,166 entitled “Personalizing Hospital Intranet Web Sites” granted to Moshfeghi et al. (“Moshfeghi et al.”), incorporated herein by reference.

Also hereby incorporated by reference is U.S. Pat. Ser. No 09/521,051 (attorney docket U.S. 00052) filed Mar. 8, 2000 for Geert Bruynsteen for BUSINESS MODEL FOR LEASING STORAGE SPACE ON A DIGITAL RECORDER

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A data recording apparatus comprising:
means for storing content information, when received, as data in a first digital format, and
means for transcoding the stored data to a second digital format, at least partially in an off-line mode, the second data format being different from the first data format.

2. The apparatus of claim 1, comprising means for storing the transcoded data.

3. The apparatus of claim 1, wherein the means for transcoding the stored data supports a multi-pass transcoding algorithm.

4. The apparatus of claim 1, comprising means for playing out the transcoded data.

5. The apparatus of claim 1, comprising a connection to interface to a network for enabling a transfer of the data.

6. The apparatus of claim 5, wherein the connection to the network supports downloading of transcoding software.

7. A data recording apparatus comprising:
at least one input;
a data processor;
a data storage device for storing content information, and a memory for storing code for at least one processing algorithm;
wherein the content information is received, as data in a first digital format, via the input and stored in the data storage device, the data is transcoded into a second format according to the at least one processing algorithm, the transcoding is done, at least partially, in an off-line mode and the second data format being different from the first data format.

8. The apparatus of claim 7, comprising a network connection for connecting to at least one of a home network and the Internet; and
wherein the data is transferred via the network

9. The apparatus of claim 7, further comprising a user interface that enables the user to select an output data format for said transcoding.

10. The apparatus of claim 7, further comprising means for modifying transcoding software.

11. The apparatus of claim 7, wherein the data storage device comprises at least one of a hard disk drive, optical memory, and a solid state memory.

12. The apparatus of claim 7, wherein the transcoded data is stored in the storage device.

13. A software application (SW) for control of playback of content information, comprising:
a storage module enabling storage of the content information; and
a transcoding module to enable a transcoding of the stored content information in at least partially an off-line mode.

14. The SW of claim 13, comprising a second storage module to enable storage of the transcoded content information in the storage device.

15. The SW of claim 13, comprising a transfer module to enable a transfer of the content information via a network, the network being one of a home network and the Internet.

16. A method of enabling playback of content information, comprising:
receiving the content information in a datastream;
storing the received content information, and transcoding the stored content information in at least partially an off-line mode.

17. The method of claim 16, comprising:
determining a system requirement of playback equipment, and providing transcoding software application based on the system requirement.

18. The method of claim 17, comprising providing the transcoding software application automatically based on the determination.

19. The method of claim 17, wherein the transcoding software application is provided upon one of a request of a user and an automatically supplied request by equipment of the user related to the playback of content.

20. The method of claim 16, comprising at least one of storing the transcoded information, and transmitting the content information.
